(19) United States
(12) Patent Application Publication
(10) Pub. No.: US 2026/0286133 A1
(43) Pub. Date: Sep. 24, 2026

(54) COLD-MIXED COLD-LAID ASPHALT MIXED PAVEMENT MATERIAL AND FABRICATION METHOD THEREFOR

(71) Applicant: Po-Yu TANG, New Taipei City (TW)

(72) Inventor: Po-Yu TANG, New Taipei City (TW)

(21) Appl. No.: 19/120,470

(22) PCT Filed: Oct. 31, 2022
(86) PCT No.: PCT/CN2022/128577

§ 371 Date: Apr. 11, 2025

(51) Int. Cl. C08L 95/00

(52) U.S. Cl. CPC C08L 95/005; C08L 2555/28; C08L 2555/34; C08L 2555/50; C08L 2555/52; C08L 2555/80

(57) ABSTRACT

A cold-mixed cold-laid asphalt mixed pavement material and its fabrication method. The asphalt concrete (AC) pavement of an existing road surface is removed, crushed into asphalt concrete slag and then recycled, and interface coagulant is added and pre-cooled to wrap and solidify the asphalt concrete slag so that it is easy to bond with water-based materials. Retarder is added to the cold mix to slow down the curing speed of the asphalt concrete slag after pre-cold mixing, and water-based light-curing resin is added to the cold mix to facilitate the bonding and adhesion between the raw material particles. The pre-cold mixing process of to produce asphalt mixed pavement material does not require the use of fuel for heating. It is laid on a predetermined road surface in a cold-laid manner, thereby reducing emissions of carbon dioxide, heat, etc. and saving electricity.

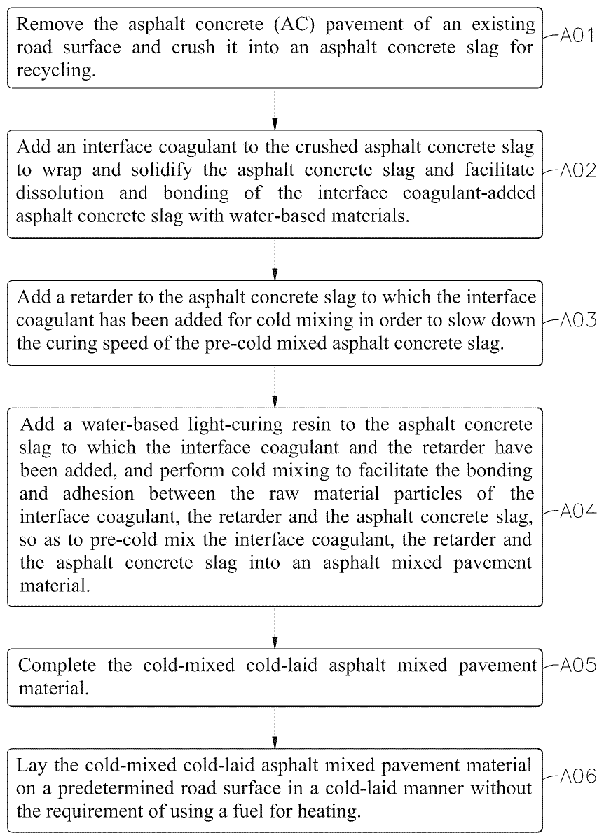

### CROSS REFERENCE TO RELATED APPLICATIONS

This application is a U.S. National Stage of International Application No. PCT/CN2022/128577, filed on Oct. 31, 2022, for which priority is claimed under 35 U.S.C. § 120, the entire contents of which are hereby incorporated by reference.

### BACKGROUND OF THE INVENTION

### 1. Field of the Invention

The present invention relates to a cold-mixed cold-laid asphalt mixed pavement material and a fabrication method thereof, and more particularly to a method for preparing asphalt mixed material without heat treatment. The method is to add an interface coagulant, a retarder and a water-based light-curing resin to the recycled asphalt concrete slag, complete the asphalt concrete (AC) pavement material through cold mixing, and then use cold paving to lay it on the predetermined road surface, so as to achieve the purpose of cold-mixed cold-laid asphalt mixed pavement material.

### 2. Description of the Related Art

With the change of living habits and living environment, in daily life, people's clothing, food, housing, transportation, entertainment and other necessities are prone to produce high carbon emissions, high waste gas, large amounts of waste, pollutants, etc. in the production and manufacturing operations, which exist in the living environment space to seriously pollute the air, water and soil, which in turn causes serious global warming and affects the survival and growth environment of all animals and plants, as well as people's physical and mental health. Therefore, people need to gradually improve their environmental awareness and try to reduce the emission of carbon dioxide and heat in daily life, so as to reduce the pollution and damage to the living environment and avoid serious adverse effects on people's physical and mental health and living environment.

In terms of transportation in daily life, roads are the necessary paths to any place, and a small number of them are country roads paved with concrete, gravel, earth and stone. Most urban roads, suburban roads, general highways, expressways, or lane streets are paved with asphalt concrete (AC) to facilitate the movement of people and vehicles. Common asphalt concrete pavement roads are prone to damage after a period of time due to sun, rain, vehicle pressure, wheel rolling, etc. Moreover, asphalt concrete ages after long-term use. Its softening point and viscosity will increase with the increase of use time, which will also lead to cracks, dents or damages on the road surface. That is, the old asphalt concrete pavement must be removed and re-paved to ensure the safety of people and vehicles using the road.

Traditionally, the old asphalt concrete pavement is removed and then discarded, which also causes environmental pollution and is not in line with environmental protection concepts and requirements. Therefore, the relevant units studied the recycling of the old asphalt concrete pavement after removing it, using 40% of the recycled asphalt concrete slag, adding 60% of the new asphalt concrete, and adding heavy oil as a regeneration agent to reduce the viscosity of the asphalt concrete (to between 3,900 cP and 8,100 cP) to meet the regulatory standards for the use of asphalt concrete. However, when asphalt concrete is generally used for road paving, fuel (such as heavy oil, kerosene or natural gas) is used to heat asphalt concrete and raw materials such as sand and gravel to keep them at a predetermined temperature for pre-mixing. The pre-mixed asphalt concrete can have a buffer time to achieve the pre-mixing effect. However, in the premix heating process of asphalt concrete, the amount of fuel required is quite large and the temperature is quite high, so the amount of waste gas emitted is also large, and the high temperature also has an indirect impact on surrounding objects, plants, etc., and the environmental pollution is quite serious. In addition, the proportion and amount of sand and gravel added to asphalt concrete are also quite large, and the process of obtaining sand and gravel will also cause damage to rivers, hillsides and forests. However, when asphalt concrete is used to pave the road, it is a common raw material for general road construction. Therefore, when asphalt concrete pavement is laid, the environmental pollution caused is also quite serious.

When premixed asphalt concrete is heated by fuel, if natural gas is used as fuel, and the main component of natural gas is methane (CH₄), then the number of moles of methane (CH₄) in natural gas [n] is calculated through the “ideal gas equation”: PV=Nrt, where it is assumed that P=1 atm+300 mmH₂O (user outlet pressure)=104,267 N/m², and the volume of natural gas at one degree V=1 m³, 1 J=1N·mR=8.314 J/mole·K, T=293·K (20° C.), so n=42.8 moles. In the above, Nis Newton and J is Joule. The combustion equation of methane (CH₄) is: CH₄+2O₂→CO₂+2H₂O. It can be seen that the combustion of 1 mole of natural gas (assuming complete combustion) will produce 1 mole of carbon dioxide [CO₂] (molecular weight 12+16*2=44).

Therefore, the carbon dioxide [CO₂] produced by burning one degree of natural gas is 42.8 moles, and the converted weight is: 42.8 moles=42.8 moles*44 g/mole=1,883.2 g≈1.88 Kg.

Therefore, when laying asphalt concrete (AC) pavement on the road, sand and gravel are added to the asphalt concrete for heating. Each ton of sand and gravel needs to consume about 14 degrees of natural gas for heating. Therefore, when one ton of asphalt concrete pavement is produced, the carbon dioxide [CO₂] emissions generated are approximately: 14*1.88=26.32 Kgs. Therefore, for road paving in Taipei Metropolitan Area in one year, the required asphalt concrete paving material is about 1,500,000 tons, which means that the carbon dioxide [CO₂] emissions are about 39,480,000 kgs, which is equivalent to 39,480 tons.

Furthermore, when using natural gas for heating, the calorific value released by each degree of natural gas is about 9,000 Kcal, that is, the production of each ton of asphalt concrete paving material requires the release of about 126,000 Kcal. After the asphalt concrete paving material is heated to the required temperature and transported to the construction site for road paving, the asphalt concrete paving material is cooled to room temperature, during which all the heat value of the asphalt concrete is dissipated into the air environment. According to the above mentioned asphalt concrete paving materials used for road paving in Taipei Metropolitan Area in one year, the total calorific value emitted is about 1.89E11 Kcal, which is about 189 billion Kcal of calorific value energy.

Therefore, it can be seen that when laying asphalt concrete pavement on roads, the amount of carbon dioxide [CO₂] and calorific value energy emitted due to heating the asphalt concrete pavement are quite considerable, and also directly cause pollution to the air and living environment, which cannot be ignored.

Therefore, how to solve the problems and troubles caused by the current use of asphalt concrete to pave the road, as well as the troubles and shortcomings such as exhaust gas emissions and high temperatures that will affect the environment, is the direction that the relevant manufacturers engaged in this industry are eager to study and improve.

### SUMMARY OF THE INVENTION

Therefore, in view of the above problems and deficiencies, the main object of the present invention is to provide a cold-mixed cold-laid asphalt mixed pavement material and a method for manufacturing the same.

The present invention provides a cold-mixed cold-laid asphalt mixed pavement material, which comprises asphalt concrete slag, interface coagulant, retarder and water-based light-curing resin, wherein the asphalt concrete slag is the asphalt concrete slag recycled from the road surface. The added interface coagulant is used to wrap and solidify the asphalt concrete slag. The interface coagulant contains calcium carbonate, magnesium carbonate, stone powder, glass powder, cement and carbon ash. The added retarder is used to slow down the curing of the premixed asphalt concrete slag, and the retarder comprises raw materials such as seaweed powder and water. As for the added water-based light-curing resin, it is used to facilitate the bonding and adhesion between the raw material particles of asphalt concrete, interface coagulant and retarder. It contains raw materials such as epoxy resin, silicone acrylic copolymer resin and water.

In the embodiment of the cold-mixed cold-laid asphalt mixed pavement material of the present invention, the asphalt concrete slag is obtained by removing the asphalt concrete (AC) pavement of the existing road surface, crushing it into asphalt concrete slag, and then recycling it.

In the embodiment of the cold-mixed cold-laid asphalt mixed pavement material of the present invention, the interface coagulant added to the asphalt concrete comprises the raw materials of 25% by weight (wt) of calcium carbonate [CaCO₃], 15% by weight (wt) of magnesium carbonate [MgCO₃], 20% by weight (wt) of stone powder, 10% by weight (wt) of glass powder, 25% by weight (wt) of cement and 5% by weight (wt) of carbon ash, and the particle size of stone powder and glass powder is less than 200 μm. The added retarder comprises 0.6% by weight (wt) of seaweed powder and 99.4% by weight (wt) of water. The added water-based light-curing resin comprises the raw materials of 30% by weight (wt) of epoxy resin, 15% by weight (wt) of silicone acrylic copolymer resin and 55% by weight (wt) of water.

The present invention also provides a fabrication method for cold-mixed cold-laid asphalt mixed pavement material, which is to remove the asphalt concrete (AC) pavement of the existing road and crush it into asphalt concrete slag for recycling, then to add an interface coagulant to wrap and solidify the asphalt concrete slag, making it easy to dissolve and bond with water-based materials, and then to add an retarder to cold mix to slow down the curing speed of the asphalt concrete slag after pre-cold mixing, and then to add a water-based light-curing resin for cold mixing to facilitate bonding and adhesion between the raw material particles, thus completing the pre-cold mixing process of asphalt mixed pavement material. The asphalt mixed pavement material does not need to be heated by fuel, and is laid on the predetermined road surface in a cold-paving manner, thereby reducing emissions of carbon dioxide, heat, etc., and saving electricity, thereby achieving the effect of energy saving and carbon reduction, and meeting environmental protection requirements.

### BRIEF DESCRIPTION OF THE DRAWINGS

The FIGURE is a flow chart of the present invention.

### DETAILED DESCRIPTION OF+ THE PREFERRED EMBODIMENT

In order to achieve the above-mentioned purpose and effect, the technical means and structure, implementation method, etc. adopted by the present invention are now described in detail with reference to the annexed drawings for the preferred embodiment of the present invention, and its features and functions are as follows, so as to facilitate a complete understanding.

Please refer to the FIGURE, which is a flow chart of the present invention. As shown in the FIGURE, it can be clearly seen that the cold-mixed cold-laid asphalt mixed pavement material of the present invention comprises an asphalt concrete slag, an interface coagulant, a retarder and a water-based light-curing resin.

The asphalt concrete slag is recycled from an asphalt concrete slag removed from a road surface.

The interface coagulant comprises raw materials such as calcium carbonate, magnesium carbonate, stone powder, glass powder, cement, and carbon ash, etc. The retarder comprises raw materials such as seaweed powder and water, etc.

The water-based light-curing resin comprises raw materials such as epoxy resin, silicone acrylic copolymer resin and water.

The interface coagulant is added to the asphalt concrete slag to wrap and solidify the asphalt concrete slag. The purpose of adding the retarder is to slow down the curing of the asphalt concrete slag after premixing. The addition of the water-based light-curing resin is to facilitate the bonding and adhesion between the raw material particles of the asphalt concrete slag, the interface coagulant and the retarder.

The interface coagulant added to the asphalt mixed pavement material comprises 25% by weight (wt) calcium carbonate [CaCO₃], 15% by weight (wt) magnesium carbonate [MgCO₃], 20% by weight (wt) stone powder, 10% by weight (wt) glass powder, 25% by weight (wt) cement and 5% by weight (wt) carbon ash. The particle size of stone powder and glass powder is less than 200 μm.

The retarder added to the asphalt mixed pavement material comprises raw materials such as 0.6% by weight (wt) of seaweed powder and 99.4% by weight (wt) of water. Furthermore, the water-based light-curing resin added to the asphalt mixed pavement material comprises 30% by weight (wt) of epoxy resin, 15% by weight (wt) of silicone acrylic copolymer resin and 55% by weight (wt) of water.

The above-mentioned cold-mixed cold-laid asphalt mixed pavement material fabrication method of the present invention is implemented according to the following steps:

(A01) Remove the asphalt concrete (AC) pavement of an existing road surface and crush the removed asphalt concrete (AC) pavement into an asphalt concrete slag for recycling.

(A02) Add an interface coagulant to the crushed asphalt concrete slag to wrap and solidify the asphalt concrete slag and facilitate dissolution and bonding of the interface coagulant-added asphalt concrete slag with water-based materials.

(A03) Add a retarder to the asphalt concrete slag to which the interface coagulant has been added for cold mixing in order to slow down the curing speed of the pre-cold mixed asphalt concrete slag.

(A04) Add a water-based light-curing resin to the asphalt concrete slag to which the interface coagulant and the retarder have been added, and perform cold mixing to facilitate the bonding and adhesion between the raw material particles of the interface coagulant, the retarder and the asphalt concrete slag, so as to pre-cold mix the interface coagulant, the retarder and the asphalt concrete slag into an asphalt mixed pavement material.

(A05) Complete the cold-mixed cold-laid asphalt mixed pavement material.

(A06) Lay the cold-mixed cold-laid asphalt mixed pavement material on a predetermined road surface in a cold-laid manner without any requirement of using a fuel for heating.

The cold-mixed cold-laid asphalt mixed pavement material fabrication method of the present invention is to perform cold premixing in a room temperature environment without heating, that is, no fuel (such as heavy oil, kerosene or natural gas, etc.) is required for heating, and no exhaust gas and high temperature are emitted, so there is no pollution or damage to the environment. The asphalt mixed pavement material is then laid on the designated road surface at room temperature to avoid any impact or damage to surrounding animals and plants caused by high temperatures. Moreover, after laying, it will not generate a large amount of calorific value and release into the air environment, which can effectively avoid pollution to the air environment.

In addition, the cold-mixed cold-laid asphalt mixed pavement material fabrication method of the present invention adopts a cold mixing process to produce asphalt mixed pavement material, which is a water-based raw material and does not require heating treatment. In the process of producing the asphalt mixed pavement material, there is no need to use exhaust fan (100 Hp), dryer (50 Hp), elevator (30 Hp), vibrating screen (30 Hp), asphalt storage tank (150 Hp), totaling about 360 Hp=270 KW of electricity. The asphalt mixed pavement material factory produces about 100 tons of asphalt mixed pavement material per hour. If the demand for asphalt mixed pavement material is 1,500,000 tons, the asphalt mixed pavement material factory needs to operate for 15,000 hours, which can save about 4,050,000 kWh of electricity. That is, the cold mixing process used in the present invention to produce asphalt mixed pavement material has unexpected effects. Furthermore, since the present invention adopts cold mixing process to make asphalt mixed pavement material, no asphalt required for gluing in traditional production of asphalt mixed pavement material is used. Therefore, the present invention adopts cold mixing process to make asphalt mixed pavement material, which can achieve the effects of non-toxicity, tastelessness and odorlessness, and can also meet the requirements of environmental protection and be friendly to the living environment.

The above description is merely a preferred embodiment of the present invention and does not limit the patent protection scope of the present invention. Therefore, any simple modifications and equivalent structural changes made using the contents of the description and drawings of the present invention should also be included in the patent protection scope of the present invention.

In summary, the cold-mixed cold-laid asphalt mixed paving material and its fabrication method described in the present invention can indeed achieve its efficacy and purpose when actually implemented and used. Therefore, the present invention is an invention with excellent practicality and meets the requirements for applying for an invention patent.

What the invention claimed is:

1. A cold-mixed cold-laid asphalt mixed pavement material, comprising an asphalt concrete slag, an interface coagulant, a retarder and a water-based light-curing resin, wherein:
said asphalt concrete slag is recycled from an asphalt concrete slag removed from a road surface;
said interface coagulant is used to wrap and solidify said asphalt concrete slag, said interface coagulant comprising calcium carbonate, magnesium carbonate, stone powder, glass powder, cement and carbon ash;
said retarder is used to slow down the curing of the pre-mixed said asphalt concrete slag, and said retarder contains seaweed powder and water; and
said water-based light-curing resin is used to facilitate the bonding and adhesion between the raw material particles of said asphalt concrete slag, said interface coagulant and said retarder, said water-based light-curing resin comprising epoxy resin, silicone acrylic copolymer resin and water.

2. The cold-mixed cold-laid asphalt mixed pavement material as claimed in claim 1, wherein said asphalt concrete slag is obtained by removing the asphalt concrete (AC) pavement of an existing road surface, crushing the removed asphalt concrete (AC) pavement into asphalt concrete slag for recycling.

3. The cold-mixed cold-laid asphalt mixed pavement material as claimed in claim 1, wherein said interface coagulant comprises 25% by weight (wt) calcium carbonate [CaCO₃], 15% by weight (wt) magnesium carbonate [MgCO₃], 20% by weight (wt) stone powder, 10% by weight (wt) glass powder, 25% by weight (wt) cement and 5% by weight (wt) carbon ash, and the particle size of said stone powder and said glass powder is less than 200 μm.

4. The cold-mixed cold-laid asphalt mixed pavement material as claimed in claim 1, wherein said retarder comprises 0.6% by weight (wt) of seaweed powder and 99.4% by weight (wt) of water.

5. The cold-mixed cold-laid asphalt mixed pavement material as claimed in claim 1, wherein said water-based light-curing resin comprises 30% by weight (wt) of epoxy resin, 15% by weight (wt) of silicone acrylic copolymer resin and 55% by weight (wt) of water.

6. A cold-mixed cold-laid asphalt mixed pavement material fabrication method, comprising steps of:
(A01) removing an asphalt concrete (AC) pavement of an existing road surface and crushing the removed said asphalt concrete (AC) pavement into an asphalt concrete slag for recycling.
(A02) adding an interface coagulant to the crushed said asphalt concrete slag to wrap and solidify said asphalt concrete slag and facilitate dissolution and bonding of said interface coagulant-added asphalt concrete slag with water-based materials.
(A03) adding a retarder to said asphalt concrete slag to which said interface coagulant has been added for cold mixing in order to slow down the curing speed of the pre-cold mixed said asphalt concrete slag.
(A04) adding a water-based light-curing resin to said asphalt concrete slag to which said interface coagulant and said retarder have been added, and performing cold mixing to facilitate the bonding and adhesion between the raw material particles of said interface coagulant, said retarder and said asphalt concrete slag, so as to pre-cold mix said interface coagulant, said retarder and said asphalt concrete slag into an asphalt mixed pavement material.
(A05) completing the desired cold-mixed cold-laid asphalt mixed pavement material.
(A06) laying said cold-mixed cold-laid asphalt mixed pavement material on a predetermined road surface in a cold-laid manner without any requirement of using a fuel for heating.

7. The cold-mixed cold-laid asphalt mixed pavement material fabrication method as claimed in claim 6, wherein said asphalt concrete slag in the step (A01) is obtained by removing the asphalt concrete (AC) pavement of an existing road surface, and then crushing the removed said asphalt concrete (AC) pavement into an asphalt concrete slag for recycling.

8. The cold-mixed cold-laid asphalt mixed pavement material fabrication method as claimed in claim 6, wherein said interface coagulant in the step (A02) comprises 25% by weight (wt) calcium carbonate [CaCO₃], 15% by weight (wt) magnesium carbonate [MgCO₃], 20% by weight (wt) stone powder, 10% by weight (wt) glass powder, 25% by weight (wt) cement and 5% by weight (wt) carbon ash, and the particle size of said stone powder and said glass powder is less than 200 μm.

9. The cold-mixed cold-laid asphalt mixed pavement material fabrication method as claimed in claim 6, wherein said retarder in the step (A03) comprises 0.6% by weight (wt) of seaweed powder and 99.4% by weight (wt) of water.

10. The cold-mixed cold-laid asphalt mixed pavement material fabrication method as claimed in claim 6, wherein said water-based light-curing resin in the step (A04) comprises 30% by weight (wt) of epoxy resin, 15% by weight (wt) of silicone acrylic copolymer resin and 55% by weight (wt) of water.
